(19) United States
(12) Patent Application Publication
(10) Pub. No.: US 2001/0004204 A1
(43) Pub. Date: Jun. 21, 2001

(54) Electronic component for a switching power circuit

(75) Inventor: Ootani Mitsuaki, Tokyo (JP)

Correspondence Address: SHAHAN ISLAM, ESQ., ROSENMAN & COLIN LLP, 575 Madison Avenue, New York, NY, 10022-2582, US

(73) Assignee: TAIYO YUDEN CO., LTD, Tokyo (JP)

(21) Appl. No.: 09/735,072

(22) Filed: Dec. 12, 2000

(30) Foreign Application Priority Data
Dec. 14, 1999 (JP) 11-355023

(51) Int. Cl. G05F 1/613; G05F 3/16

(52) U.S. Cl. 323/224; 323/284

(57) ABSTRACT

An electronic component helps realize the miniaturization of an electronic appliance with excellent applicability to a variety of rectification circuits. The electronic component 10 includes within a package FETs 21 and 22, and a switching control integrated circuit 23. Sources and drains of the FETs 21 and 22 are connected to exterior terminals 12a to 12d, respectively, and gates of the FETs 21 and 22 are connected to control signal output terminals 23a and 23b, respectively. An output voltage input terminal 23c, a mode setup signal input terminal 23d, a ground terminal 23e and a power source terminal 23f of the switching control integrated circuit 23 are coupled to the exterior terminals 12e to 12h. An operation mode of the switching control integrated circuit 23 is selectively set up in accordance with one of the synchronous rectifications including a step-back mode, an inversion mode, a step-boost mode, or the like by connecting required components in the selected rectification mode and transmitting the selected mode control signal through a mode setup terminal 12f.

### FIELD OF THE INVENTION

The present invention relates to an electronic component for a switching power circuit; and, more particularly, to an electronic component for a switching power circuit having two or more separate switching semiconductor devices and a control circuit thereof within a single package.

### DESCRIPTION OF THE PRIOR ART

Switching power circuits such as a DC-to-DC converter are well known and switching semiconductor devices, e.g., a transistor, a field effect transistor, are utilized to control an intermittent flow of a direct current, wherein the direct current is smoothed by a coil or a capacitor, thereby generating an output voltage different from a corresponding input voltage.

A large number of small-sized electronic appliances powered by a battery such as a dry cell have been developed, to which a switching power circuit described above has been widely applied to convert an input voltage from a direct current source into a different voltage.

There exist various modes of switching power circuits including a step-back mode, an inversion mode, a step-boost mode and the like and each mode has a different circuit structure.

A switching control circuit to control an on-off conversion of the switching semiconductor device has already been integrated in some of the switching power circuits and has been circulated in the market as a switching control integrated circuit (IC).

For example, a switching control IC such as TL1451 of Texas Instruments Inc. is designed for use in various modes of switching power circuits mentioned above, and thus has wide range of applications.

Stiff competition in the market has intensified the demand in the electronic devices to extend the expected life span of a battery for longer use thereof. Accordingly, a synchronous rectification circuit has been developed to improve the conversion efficiency of a switching power circuit.

A switching control circuit has been integrated in the synchronous rectification circuit to be used as a switching control IC to control the on-off operation of the switching semiconductor. The switching control circuit, however, functions only in a certain synchronous rectification mode.

Specifically, the switching control IC for controlling the operation of the switching semiconductor device with the synchronous rectification circuit can be used only in a certain rectification mode. In other words, the conventional switching control IC has a limited applicability.

Further, in manufacturing the switching power circuit by using the synchronous rectification circuit, the switching semiconductor device and the switching control IC are embedded onto the substrate separately, thereby increasing the space for components embedment as well as the number of manufacturing processes and components involved. Moreover, when the power circuit adopting the synchronous rectification circuit is used in electronic equipment of various modes, the increase of the space for embedding the components hampers the miniaturization of the electronic appliances.

### SUMMARY OF THE INVENTION

It is, therefore, an object of the present invention to provide an electronic component with a broadened applicability for a switching power circuit.

In accordance with a preferred embodiment of the present invention, there is provided an electronic component comprising:

a package;

a plurality of exterior control terminals connected to the package;

at least two switching semiconductor devices connected to the package;

a plurality of exterior input and output terminals connected to the package and to input and output terminals of said at least two switching semiconductor devices; and

a switching control circuit embedded within the package and connected to control terminals of said at least two switching semiconductor devices and to the exterior control terminals, wherein the switching control circuit manages an on-off conversion of said at least two semiconductor devices in response to an operation mode corresponding to a mode controlling signal inputted from the exterior control terminals.

### BRIEF DESCRIPTION OF THE DRAWINGS

The above and other objects and features of the present invention will become apparent from the following description of preferred embodiments given with reference to the accompanying drawings in which:

FIG. 1 provides a block diagram for illustrating an electric circuit of an electronic component in accordance with a first embodiment of the present invention;

FIG. 2 sets forth a perspective view of an electronic component in accordance with the first embodiment of the present invention;

FIG. 3 depicts a perspective view of a semiconductor chip in accordance with the first embodiment of the present invention;

FIG. 4 presents a perspective view of a multi chip in accordance with the first embodiment of the present invention;

FIG. 5 offers a circuit diagram for describing a step-back synchronous rectification DC-to-DC converter using the electronic component in accordance with the first embodiment of the present invention;

FIG. 6 represents a circuit diagram of an inversion synchronous rectification DC-to-DC converter using the electronic component in accordance with a second embodiment of the present invention;

FIG. 7 charts a circuit diagram for demonstrating a step-boost rectification DC-to-Dc converter with the electronic component applied thereto in accordance with a third embodiment of the present invention;

FIG. 8 shows a circuit diagram of a step-back chopper DC-to-DC converter using the electronic component in accordance with a fourth embodiment of the present invention;

FIG. 9 describes a circuit diagram of an inversion chopper DC-to-DC converter utilizing the electronic component in accordance with a fifth embodiment of the present invention;

FIG. 10 displays a circuit diagram of a step-boost chopper DC-to-DC converter with the electronic component applied thereto in accordance with a sixth embodiment of the present invention; and

FIG. 11 exhibits a perspective view of a package in accordance with the present invention.

### DETAILED DESCRIPTION OF THE PREFERRED EMBODIMENT

The following are descriptions of preferred embodiments of the present invention given with reference to the accompanying drawings.

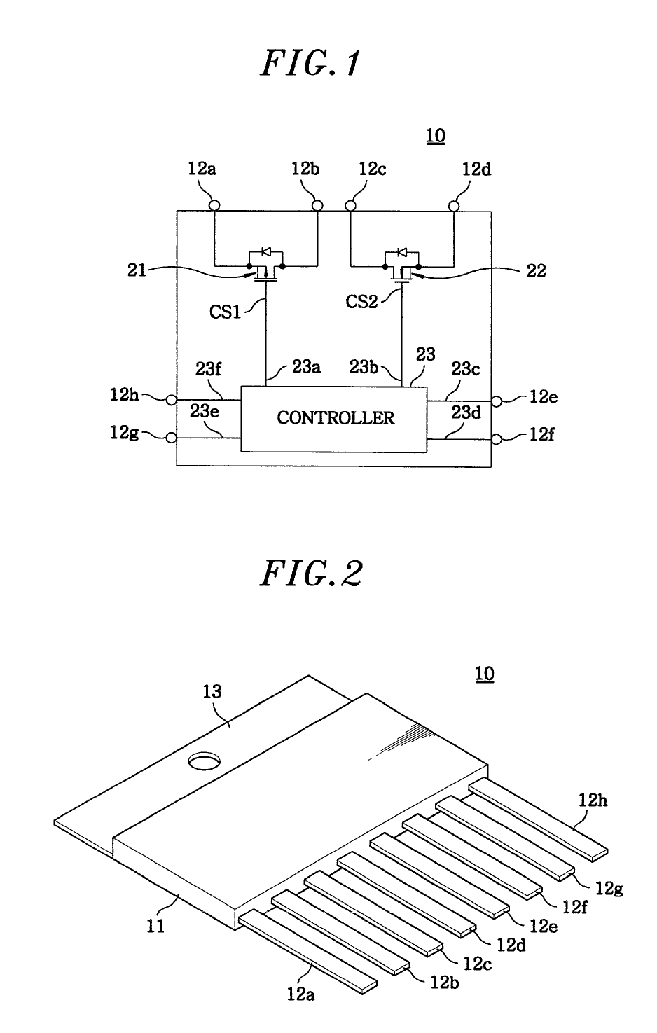

FIG. 1 is a block diagram of an electronic component for a switching power circuit and FIG. 2 is a perspective view thereof in accordance with a first embodiment of the present invention. The electronic component 10 for the switching power circuit comprises a P channel field effect transistor 21 (hereinafter referred to as P-FET), an N channel FET 22 (hereinafter referred to as N-FET) and a switching control integrated circuit 23 (hereinafter referred to as a controller).

The controller 23 includes control signal output terminals 23a and 23b generating control signals CS1 and CS2 of the P-FET 21 and the N-FET 22, respectively, an output voltage control signal input terminal 23c, a mode setup signal input terminal 23d, a ground terminal 23e, and a power source terminal 23f. The controller 23 sets up an operation mode based on a mode control signal inputted from outside through the mode setup signal input terminal 23d, so that a switching control signal is fed into the FETs 21 and 22, wherein the switching control signal represents a synchronous rectification mode such as a step-back mode, an inversion mode, a step-boost mode, or the like.

The electronic component 10 takes the shape of a common single in-line package (SIP) and includes a package 11, eight exterior terminals 12a to 12h and a heat radiation plate 13.

A source and a drain of the P-FET 21 are coupled to the exterior terminals 12a and 12b, respectively, and a source and a drain of the N-FET 22 to the exterior terminals 12d and 12c, respectively. Two gates of the FETs 21 and 22 are connected to control signal output terminals 23a and 23b of the controller 23, respectively, and two control signal input terminals and two power source terminals 23c to 23f are coupled to the exterior terminals 12e to 12h, respectively.

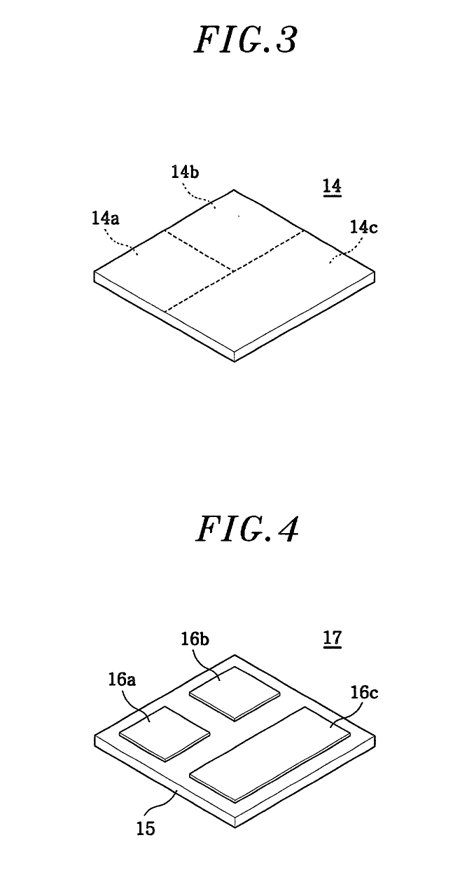

A square or rectangular shaped semiconductor chip 14 is laid within the package 11, the semiconductor chip 14 being divided into three regions 14a to 14c as illustrated in FIG. 3. The circuit shown in FIG. 1 is formed within the semiconductor chip 14, in which the eight lead terminals 12a to 12h are coupled to the sources and the drains of the FETs 21 and 22, the control signal input terminals of the controller 23 and the power source terminals thereof.

The P-FET 21 is established on a first region 14a of the semiconductor chip 14, the first region 14a occupying a quarter of the whole semiconductor chip 14. The N-FET 22 is formed on a second region 14b which is adjacent to the first region of the semiconductor chip 14 and occupies another quarter of the semiconductor chip. The controller is created on the third region 14c of the semiconductor chip 14 that occupies a half of the whole semiconductor chip.

A multi chip 17, including a plurality of semiconductor chips 16a to 16c on an insulator substrate 15, can be used instead of the semiconductor chip 14 as shown in FIG. 4. In such an event, it is preferable that a semiconductor chip 16a having the P-FET 21, a semiconductor chip 16b having the N-FET 22 and a semiconductor chip 16c having the controller 23 be formed separately from one another for an efficient heat release and insulation.

The electronic component 10 having the above structure can be used to easily form synchronous rectification circuits of various modes that are being commonly used in the conventional electronic appliances.

Referring to FIG. 5, there is illustrated a DC-to-DC converter 30 including a step-back mode synchronous rectification circuit in accordance with the first embodiment of the present invention, wherein a smoothing condenser 32 is adjoined between ground and an input terminal 31a which is in turn connected to an exterior input terminal 12a of the electronic component 10. A choke coil 33 is linked between an exterior terminal 12c of the electronic component 10 and an output terminal 31b. A capacitor 34 is connected between an output terminal 31b and ground.

The exterior terminals 12b and 12c of the electronic component 10 are coupled to each other while the exterior terminal 12d is grounded. The exterior terminal 12e of the electronic component 10 is connected to the output terminal 31b, and an output voltage is inputted into the controller 23 therethrough. An exterior terminal 12g of the electronic component 10 is grounded, and the input terminal 31a is adjoined to an exterior terminal 12h, thereby supplying the electronic component 10 with power.

The step-back mode is set up through an exterior terminal 12f in the circuit illustrated above, so that the DC-to-DC converter 30 including the step-back mode synchronous rectification circuit can be easily formed.

Other modes of DC-to-DC converters including different synchronous rectification circuits can also be built with ease.

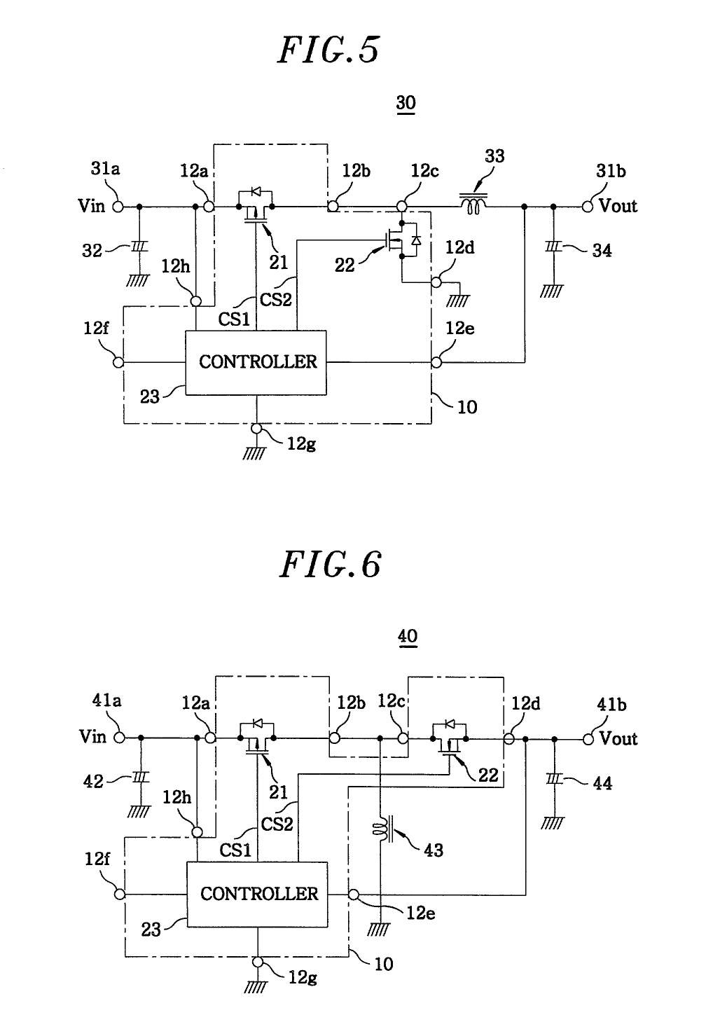

Referring to FIG. 6, there is described a DC-to-DC converter 40 containing an inversion mode synchronous rectification circuit in accordance with a second embodiment of the present invention. A smoothing capacitor 42 is connected between ground and an input terminal 41a to which the exterior output terminal 12a of the electronic component 10 is linked. The exterior terminal 12d of the electronic component 10 is connected to an output terminal 41b, while a capacitor 44 is coupled between the output terminal 41b and ground.

The exterior terminals 12b and 12c of the electronic component 10 are interconnected, while a choke coil 43 is linked between the exterior terminal 12c and ground. The exterior terminal 12e of the electronic component 10 is connected to the output terminal 41b, thereby allowing an output voltage to be inputted into the controller 23. The exterior terminal 12g of the electronic component 10 is grounded and the exterior terminal 12h is adjoined to the input terminal 41a to supply the electronic component 10 with power. An inversion mode is set up at a beginning stage through the external terminal 12f.

The DC-to-DC converter including an inversion mode synchronous rectification circuit can also be easily structured by utilizing the same electronic component 10 as shown in the first embodiment.

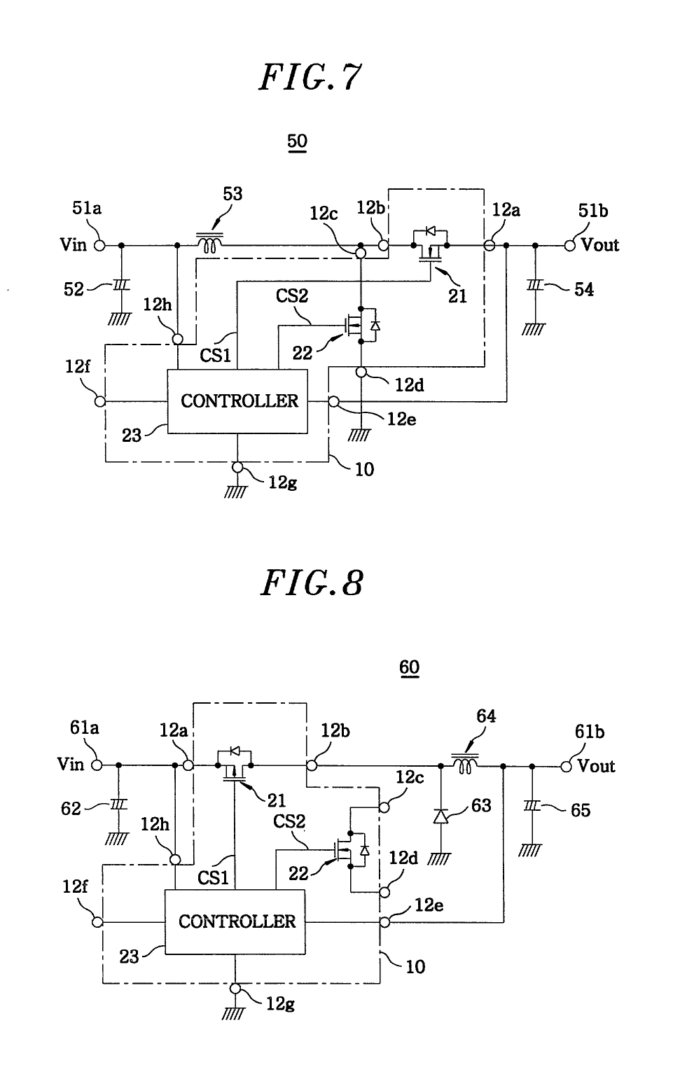

In FIG. 7, there is shown a DC-to-DC converter 50 having a step-boost synchronous rectification circuit in accordance with a third embodiment of the present invention.

A smoothing condenser 52 is connected between an input terminal 51a and ground, and the exterior input terminal 12a of the electronic component 10 is coupled to an output terminal 51b. A choke coil 53 is linked between the exterior terminal 12b of the electronic component 10 and the input terminal 51a, and a capacitor 54 is connected between the output terminal 51b and ground.

The exterior terminals 12b and 12c of the electronic component 10 are interconnected and the exterior terminal 12d is led to ground. The exterior terminal 12e of the electronic component 10 is coupled to the output terminal 51b, thereby inputting an output voltage into the controller 23. The exterior terminal 12g of the electronic component 10 is grounded and the exterior terminal 12h is connected to the input terminal 51a to power the electronic component 10. A step-boost mode is accomplished through the exterior terminal 12f at a beginning stage.

By using the electronic component 10 as in the first embodiment, the DC-to-DC converter 50 with the step-boost synchronous rectification circuit can easily be fabricated.

Referring to FIG. 8, there is displayed a step-back chopper mode DC-to-DC converter 60 in accordance with a fourth embodiment of the present invention. A smoothing condenser 62 is linked between an input terminal 61a and ground, and the exterior terminal 12a of the electronic component 10 is coupled to the input terminal 61a. A choke coil 64 is coupled between the exterior terminal 12b of the electronic component 10 and an output terminal 61b. A cathode of a diode 63 is connected to the exterior terminal 12b, wherein an anode of the diode 63 is grounded. A capacitor 65 is coupled between the output terminal 61b and ground.

In order to input an output voltage into the controller 23, the exterior terminal 12e of the electronic component 10 and the output terminal 61b are interconnected. The exterior terminal 12g of the electronic component 10 is connected to ground and the exterior terminal 12h is adjoined to the input terminal 61a to provide the electronic component 10 with power. The step-back chopper mode is set up through the exterior terminal 12f at a beginning stage of the electronic component 10.

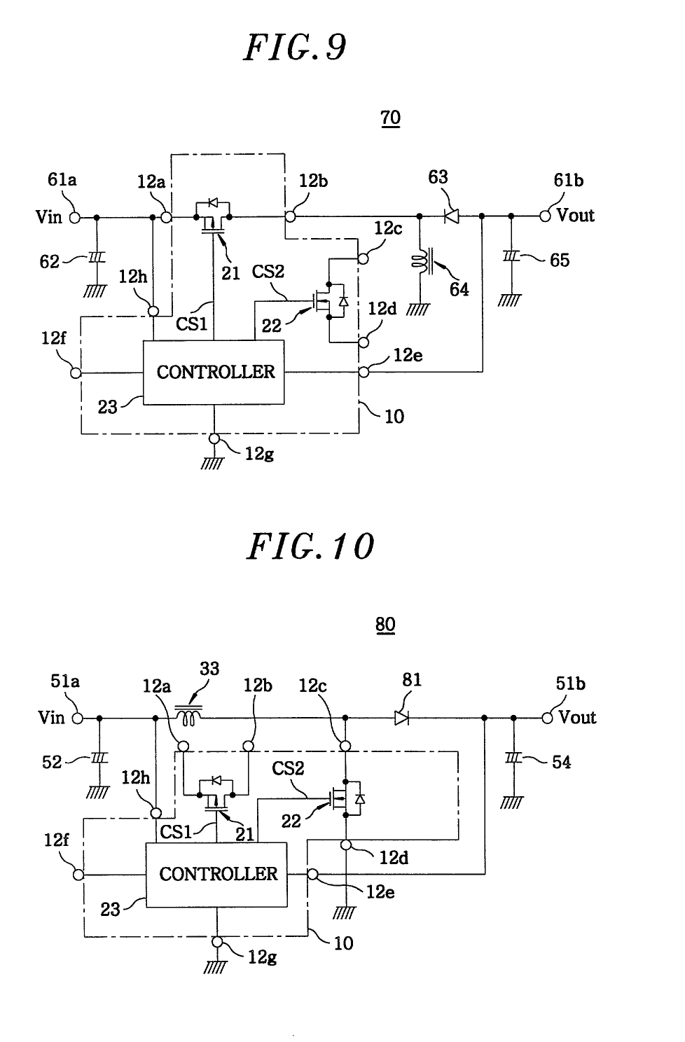

Referring to FIG. 9, an inversion mode chopper DC-to-DC converter 70 is presented in accordance with a fifth embodiment of the present invention. The inversion chopper mode DC-to-DC converter 70 can be constructed by exchanging the locations of the diode 63 and the choke coil 64 in the above-mentioned step-back chopper DC-to-DC converter 60 shown in the fourth embodiment. The inversion chopper mode is set up through the exterior terminal 12f at the beginning stage.

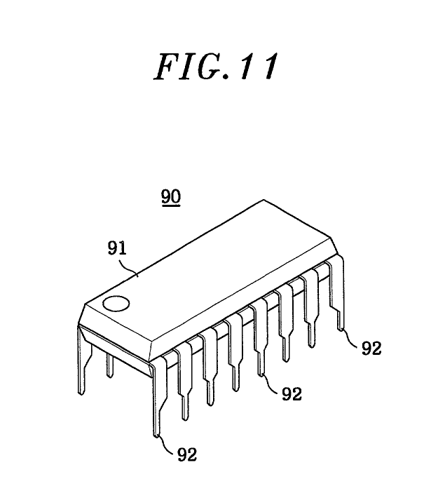

In FIG. 10, there is illustrated a step-boost chopper mode DC-to-DC converter 80 in accordance with a sixth embodiment of the present invention. The step-boost chopper DC-to-DC converter 80 may be built by replacing the FET 21 with a diode 81 in the DC-to-DC converter 50 including the step-boost mode synchronous rectification circuit shown in the third embodiment of the invention. The step-boost chopper mode is performed through the exterior terminal 12f at the beginning stage.

In the above-mentioned embodiments, the electronic component 10 takes the shape of SIP type with a package 11, the external terminals 12a to 12h and a heat radiation plate 13. An electronic component 90, however, can be organized with a package 91 of the DIP (dual in-line package) type or the CSP (chip size package) type or BGA (ball grid array) type.

Instead of the FETs 21 and 22 which are utilized as switching semiconductor devices in the preceding embodiments, NPN or PNP type of transistors can be employed. The electronic component may be formed with three or more switching semiconductor devices. In addition, it can be understood that while the switching semiconductor device is embedded within the package in the preceding embodiments, the switching semiconductor device may be situated outside the package.

The present invention enables various kinds of synchronous rectification circuits with a step-back mode, an inversion mode and a step-boost mode, and chopper rectification circuits of a step-back mode, an inversion mode and a step-boost mode to be selectively constructed with ease by changing the connections of the exterior terminals in accordance with the synchronous rectification mode and by converting the operation mode in response to the mode control signal. Further, since both switching semiconductor devices and controller thereof are embedded within a single package, there is no need to separately install the switching semiconductor devices and the switching control IC thereof on the substrate, in manufacturing the switching power circuit, thereby reducing the space for components embedment and also reducing the number of manufacturing processes and components involved. Particularly, the reduction in the space for embedding the components tremendously contributes to the miniaturization of the electronic appliances.

While the present invention has been described with respect to the particular embodiments, it will be apparent to those skilled in the art that various changes and modifications may be made without departing from the sprit and scope of the invention as defined in the following claims.

What is claimed is:

1. An electronic component, comprising:
(a) a package;
(b) a plurality of exterior control terminals included in the package;
(c) at least two switching semiconductor devices connected to the package;
(d) a plurality of exterior input and output terminals connected to the package and to input and output terminals of said at least two switching semiconductor devices; and
(e) a switching control circuit embedded within the package and connected to control terminals of said at least two switching semiconductor devices and to the exterior control terminals, wherein the switching control circuit controls an on-off conversion of said at least two semiconductor devices in response to an operation mode corresponding to a mode control signal inputted from the exterior control terminals.

2. The electronic component of claim 1, wherein said at least two switching semiconductor devices are field effect transistors.

3. The electronic component of claim 1, wherein the switching control circuit has at least two operation modes among a step-back synchronous rectification mode, an inversion synchronous rectification mode, a step-boost synchronous rectification mode, a step-back chopper mode, an inversion chopper mode and a step-boost chopper mode.

4. The electronic component of claim 1, wherein the switching semiconductor devices and the switching control circuit are formed on a single semiconductor chip.

5. The electronic component of claim 1, wherein one of the switching semiconductor devices constitutes a portion of a chopper rectification circuit controlled by the switching control circuit.

6. The electronic component of claim 1, wherein the switching semiconductor devices constitute a part of a synchronous rectification circuit controlled by the switching control circuit.
